(19) United States
(12) Patent Application Publication
(10) Pub. No.: US 2008/0232307 A1
(43) Pub. Date: Sep. 25, 2008

(54) Method and apparatus to allocate resources for acknowledgments in communication systems

(76) Inventors: Zhouyue Pi, Richardson, TX (US); Farooq Khan, Allen, TX (US); Jiannan Tsai, Plano, TX (US); Cornelius Van Rensburg, Dallas, TX (US); Yinong Ding, Plano, TX (US)

Correspondence Address: ROBERT E. BUSHNELL, 1522 K STREET NW, SUITE 300, WASHINGTON, DC, 20005-1202, US

(21) Appl. No.: 12/073,811

(22) Filed: Mar. 10, 2008

Related U.S. Application Data
(60) Provisional application No. 60/919,620, filed on Mar. 23, 2007.

(51) Int. Cl. H04Q 7/00

(52) U.S. Cl. 370/328

(57) ABSTRACT

A method and apparatus for transmission between a plurality of units of user equipment and a base station in a wireless communication system. For each of the units of user equipment, a plurality of control channel elements are mapped to a plurality of downlink acknowledgement channel resources in accordance with a first mapping scheme, and the plurality of control channel elements are mapped to a plurality of uplink acknowledgement channel resources in accordance with a second mapping scheme. The first mapping scheme and the second mapping scheme may be different for different units of user equipment. Alternatively, the first mapping scheme and the second mapping scheme may change over time.

### CLAIM OF PRIORITY

This application makes reference to, incorporates the same herein, and claims all benefits accruing under 35 U.S.C. §119 from a provisional application earlier filed in the U.S. Patent & Trademark Office on 23 Mar. 2007 and there duly assigned Ser. No. 60/919,620.

### BACKGROUND OF THE INVENTION

1. Field of the Invention

The present invention relates to a method and an apparatus for transmission between a plurality of units of user equipment and a base station in a wireless communication system; more particularly, the present invention relates to a method and an apparatus for allocating acknowledgement resources in communication systems.

2. Description of the Related Art

Telecommunication enables transmission of data over a distance for the purpose of communication between a transmitter and a receiver. The data is usually carried by radio waves and is transmitted using a limited transmission resource. That is, radio waves are transmitted over a period of time using a limited frequency range.

In a contemporary communication system, the information to be transmitted are first encoded and then modulated to generate multiple modulation symbols. The symbols are subsequently mapped into transmission resource. Usually, the transmission resource available for data transmission is segmented into a plurality of equal duration time and frequency slots, so called resource elements. A single resource element or multiple resource elements may be allocated for transmitting the data. When data is transmitted, a control signal may accompany the data to carry information regarding the allocation of the resource elements for the current data transmission. Therefore, when a receiver receives the data and the control signal, the receiver may derive the information regarding resource allocation used for data transmission from the control signal and decodes the received data using the derived information.

During an uplink transmission in the Third (3^{rd}) Generation Partnership Project Long Term Evolution (3GPP LTE) systems, a unit of user equipment (UE) transmits a data packet to a base station (BS) after receiving an uplink scheduling grant (i.e., uplink grant) from the BS. In response to the received data packet from the UE, the BS transmits a downlink acknowledgement message (i.e., downlink ACK) to the UE. During a downlink transmission, a BS transmits a data packet to a UE after transmitting a downlink scheduling grant (i.e., downlink grant) to the UE. In response to the received data packet from the BS, the UE transmits an uplink acknowledgement message (i.e., uplink ACK) to the UE.

Contemporarily, information regarding the allocation of ACK channel resources is transmitted via either explicit signaling or linking to data channel resources. Explicit signaling of ACK channel resource may result in large overhead. Linking ACK channel resources to data channel resources may result in large amount of ACK channel resource requirement, regardless of the actual system load.

### SUMMARY OF THE INVENTION

It is therefore an object of the present invention to provide an improved method and apparatus for communication.

It is another object of the present invention to provide a method and apparatus for efficiently allocating communication resources for acknowledgement messages.

According to one aspect of the present invention, a method for transmission is provided. A mapping scheme between a plurality of control channel elements and a plurality of acknowledgement channel resources is established. When a control channel element selected from the plurality of control channel elements is used to transmit a scheduling grant, a second node transmits a data packet to a first node according to the scheduling grant. Then, one of an acknowledgement message and a negative acknowledgement message is transmitted from the first node to the second node using an acknowledgement channel resource selected from the plurality of acknowledgement channel resources in accordance with the mapping scheme.

The mapping scheme may include at least one mapping relationship selected from a group of mapping relationships including: one acknowledgement channel resource corresponding to one control channel element; one acknowledgement channel resource corresponding to more than one control channel element; more than one acknowledgement channel resource corresponding to one control channel element; and more than one acknowledgement channel resource corresponding to more than one control channel element.

The first node may be a base station, and the second node may be a unit of user equipment. In this case, the scheduling grant is an uplink scheduling grant transmitted from the base station to the unit of user equipment, and the acknowledgement channel resources are downlink acknowledgement channel resources.

The mapping scheme may change for different unit of user equipment.

Alternatively, the first node may be a unit of user equipment, and the second node may be a base station. In this case, the scheduling grant is a downlink scheduling grant transmitted from the base station to the unit of user equipment, and the acknowledgement channel resources are uplink acknowledgement channel resources.

The mapping scheme may change over time.

The mapping scheme may change in dependence upon one of information regarding Hybrid automatic repeat-request transmission, and information regarding Multiple-Input Multiple-Output configuration comprised of rank information and whether a grant is a Multiple-Input Multiple-Output grant, or a multiple codeword grant, or a single codeword grant.

Accordingly to another aspect of the present invention, a method for communication is provided. A plurality of first mapping schemes are established between a plurality of control channel elements and a plurality of downlink acknowledgement channel resources for a plurlaity of units of user equipment. A plurality of second mapping schemes are established between the plurality of control channel elements and a plurality of uplink acknowledgement channel resources for the plurlaity of units of user equipment. When any one of the pluraltiy of units of user equipment receives an uplink scheduling grant from a base station via a control channel element and the unit of user equipment transmits a data packet to the base station, the base station transmits one of a downlink acknowledgement message and a downlink negative acknowledgement message by using at least one downlink acknowledgement channel resource that is associated with the control channel element in accordance with the first mapping scheme that corresponds to the unit of user equipment. When any one of the plurality of units of user equipment receives a downlink scheduling grant from a base station via a control channel element and the base station transmits a data packet to the user equipement, the unit of user equipment transmits one of an uplink acknowledgement message and an uplink negative acknowledgement message by using at least one uplink acknowledgement channel resource that is associated with the control channel element in accordance with the second mapping scheme that corresponds to the unit of user equipment.

In accordance with the first mapping schemes, more than one control channel element may correspond to one downlink acknowledgement channel resource. In accordance with the second mapping schemes, more than one control channel element may correspond to one uplink acknowledgement channel resource.

At least one of the first mapping schemes may be different from the other first mapping schemes. At least one of the second mapping schemes may be different from the other second mapping schemes.

The first mapping scheme of at least a first user equipment may be different from the first mapping scheme of at least a second user equipment.

The second mapping scheme of at least a first user equipment may be different from the second mapping scheme of at least a second user equipment.

The first mapping schemes in at least a first transmission interval may be different from the first mapping schemes in at least a second transmission interval.

The second mapping schemes in at least a first transmission interval may be different from the second mapping schemes in at least a second transmission interval.

According to still another aspect of the present invention, a method for communication is provided. A plurality of mapping schemes are established between a plurality of control channel elements and a plurality of downlink acknowledgement channel resources for corresponding ones of a plurality of units of user equipment. When any one of the plurality of units of user equipment receives an uplink scheduling grant from a base station via a control channel element selected from the plurality of control channel elements and the unit of user equipment transmits a data packet to the base station, the base station transmits one of a downlink acknowledgement message and a downlink negative acknowledgement message by using at least one downlink acknowledgement channel resource that is associated with the control channel element in accordance with a mapping scheme corresponding to the unit of user equipment.

At least one of the mapping schemes may be different from the other mapping schemes.

When there are N downlink acknowledgement channel resources and M units of user equipment, the index CCE(i,j) for the control channel element that corresponds to an i-th downlink acknowledgement channel resource for a j-th unit of user equipment may be established as: CCE(i,j)=(i+j) mod N, for j=0, 1, . . . M-1.

Alternatively, the index CCE(i,j) for the control channel element that corresponds to an i-th downlink acknowledgement channel resource for a j-th unit of user equipment being established as: CCE(i,j)=(i+f(j)) mod N, for j=0, 1, . . . M-1, where f(j) is a certain function of j, such as a Hash function.

When anyone of the units of user equipment receives a downlink negative acknowledgement message from the base station, the unit of user equipment may retransmit a data packet.

At least one mapping scheme may change over time.

According to a further aspect of the present invention, a base station is provided in a wireless communication system. A plurality of first mapping schemes are established between a plurality of control channel elements and a plurality of downlink acknowledgement channel resources for a plurlaity of units of user equipment are established, and a plurality of second mapping schemes are established between the plurality of control channel elements and a plurality of uplink acknowledgement channel resources for the plurlaity of units of user equipment. When any one of the pluraltiy of units of user equipment receives an uplink scheduling grant from the base station via a control channel element and the unit of user equipment transmits a data packet to the base station, the base station transmits one of a downlink acknowledgement message and a downlink negative acknowledgement message by using at least one downlink acknowledgement channel resource that is associated with the control channel element in accordance with the first mapping scheme that corresponds to the unit of user equipment.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an illustration of an Orthogonal Frequency Division Multiplexing (OFDM) transceiver chain suitable for the practice of the principles of the present invention;

FIG. 2 is an illustration of OFDM subcarriers;

FIG. 3 is an illustration of OFDM symbols in a time domain;

FIG. 4 is an illustration of single carrier frequency division multiple access transceiver chain;

FIG. 5 is an illustration of a Hybrid Automatic Repeat request (HARQ) transceiver chain;

FIG. 6 is an illustration of a four-channel HARQ transmission scheme;

FIG. 7 is an illustration of a Multiple Input Multiple Output (MIMO) system;

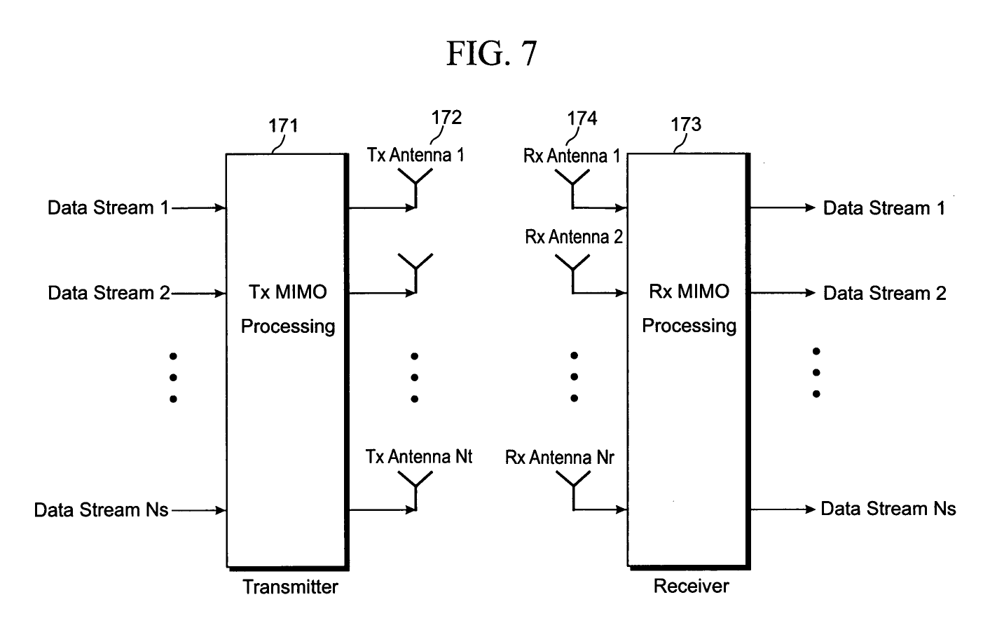

FIG. 8 is an illustration of a precoded MIMO system;

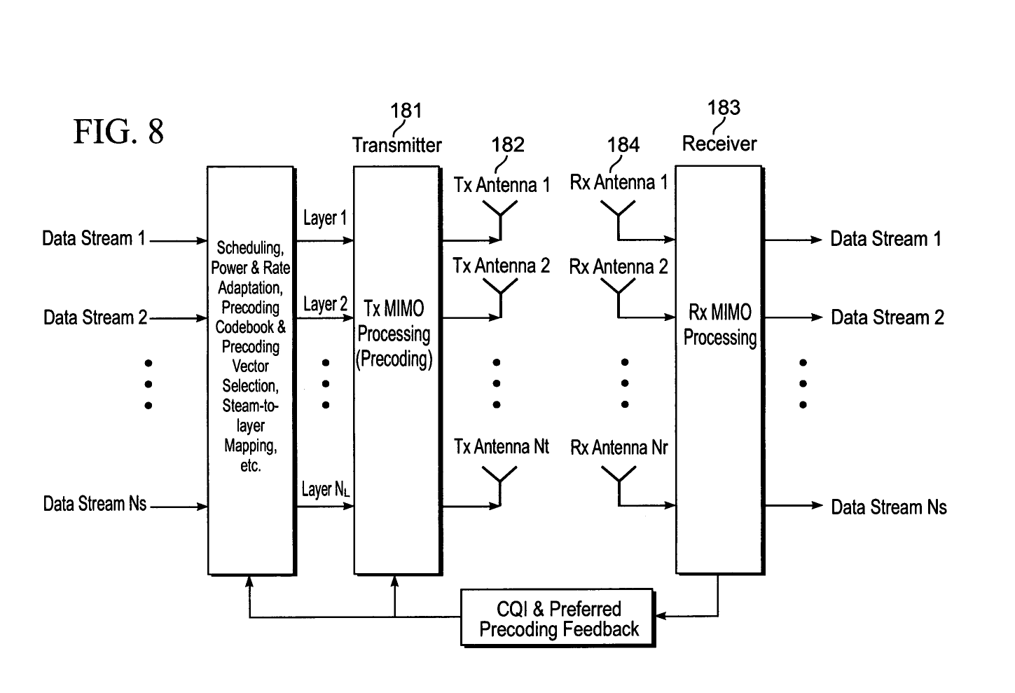

FIG. 9 is an illustration of LTE downlink control channel elements;

FIG. 10 illustrates a mapping scheme from control channel elements to downlink acknowledgement (ACK) channel resources, and from the control channel elements to uplink ACK channel resources in accordance with an embodiment according to the principles of the present invention;

FIG. 11 illustrates another mapping scheme from control channel elements to downlink acknowledgement (ACK) channel resources, and from the control channel elements to uplink ACK channel resources in accordance with another embodiment according to the principles of the present invention;

FIG. 12 illustrates a scheme when ACK channel resources are preempted by the usage for scheduling grants;

FIG. 13A illustrates a mapping scheme where separate control channel elements are mapped to either downlink ACK channel resources or uplink ACK channel resource, and FIG. 13B illustrates a mapping scheme where multiple control channel elements are mapped to either downlink ACK channel resources or uplink ACK channel resource in accordance with one embodiment according to the principles of the present invention;

FIG. 14A illustrates a mapping scheme where separate control channel elements are mapped to either downlink ACK channel resources or uplink ACK channel resource, and FIG. 14B illustrates a mapping including a mixed mapping relationships in accordance with another embodiment according to the principles of the present invention;

FIG. 15 illustrates a scheme of ACK resource collision;

FIG. 16 illustrates a mapping scheme between control channel element and downlink ACK channel resources in accordance with still another embodiment according to the principles of the present invention;

FIG. 17 illustrates Hybrid Automatic Repeat-reQuest transmissions using mapping scheme based on different units of user equipment or different time, in accordance with a further embodiment according to the principles of the present invention; and

FIG. 18 illustrates Hybrid Automatic Repeat-reQuest transmissions using mapping scheme based on transmission index, in accordance with a still further embodiment according to the principles of the present invention.

### DETAILED DESCRIPTION OF THE INVENTION

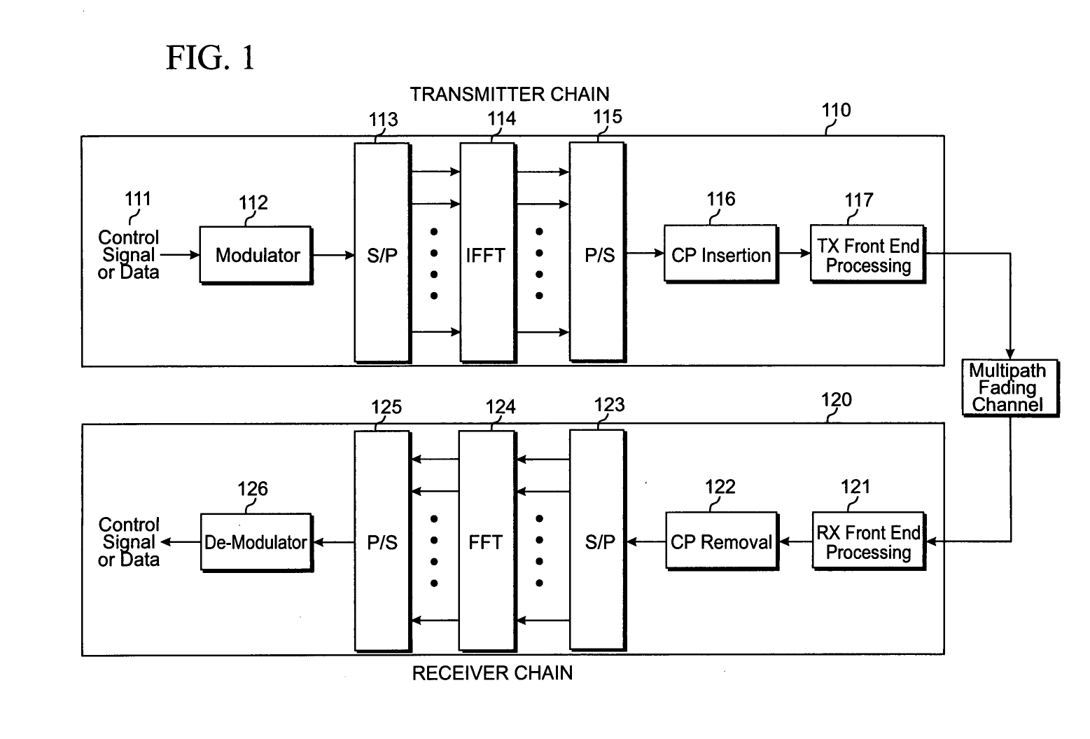

FIG. 1 illustrates an Orthogonal Frequency Division Multiplexing (OFDM) transceiver chain. In a communication system using OFDM technology, at transmitter chain 110, control signals or data 111 is modulated by modulator 112 into a series of modulation symbols, which are subsequently serial-to-parallel converted by Serial/Parallel (S/P) converter 113. Inverse Fast Fourier Transform (IFFT) unit 114 is used to transfer the signals from frequency domain to time domain into a plurality of OFDM symbols. Cyclic prefix (CP) or zero prefix (ZP) is added to each OFDM symbol by CP insertion unit 116 to avoid or mitigate the impact due to multipath fading. Consequently, the signal is transmitted by transmitter (Tx) front end processing unit 117, such as an antenna (not shown), or alternatively, by fixed wire or cable. At receiver chain 120, assuming perfect time and frequency synchronization are achieved, the signal received by receiver (Rx) front end processing unit 121 is processed by CP removal unit 122. Fast Fourier Transform (FFT) unit 124 transfers the received signal from time domain to frequency domain for further processing.

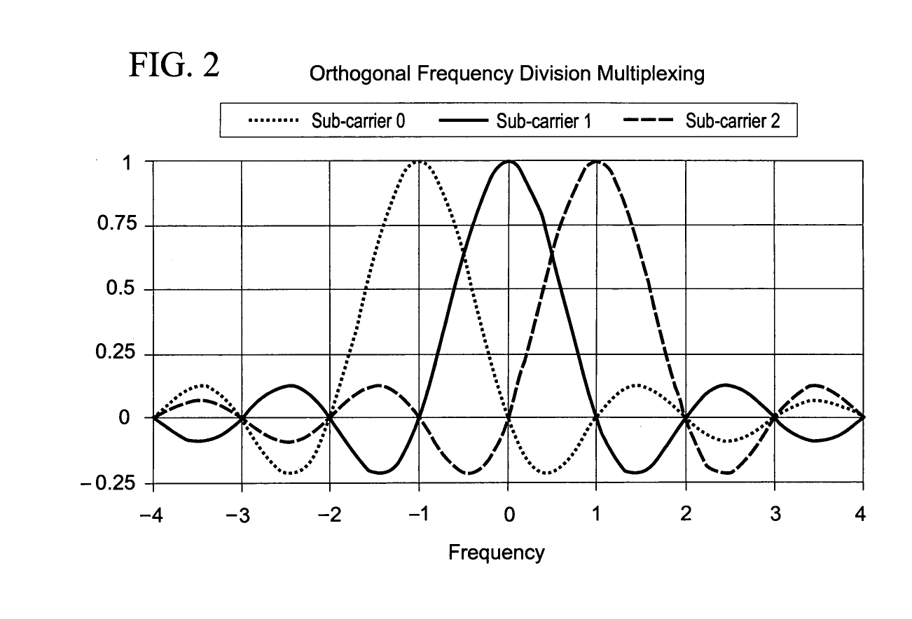

In a OFDM system, each OFDM symbol consists of multiple sub-carriers. Each sub-carrier within an OFDM symbol carriers a modulation symbol. FIG. 2 illustrates the OFDM transmission scheme using sub-carrier 1, sub-carrier 2, and sub-carrier 3. Because each OFDM symbol has finite duration in time domain, the sub-carriers overlap with each other in frequency domain. The orthogonality is maintained at the sampling frequency assuming the transmitter and the receiver has perfect frequency synchronization, as shown in FIG. 2. In the case of frequency offset due to imperfect frequency synchronization or high mobility, the orthogonality of the sub-carriers at sampling frequencies is destroyed, resulting in inter-carrier-interference (ICI).

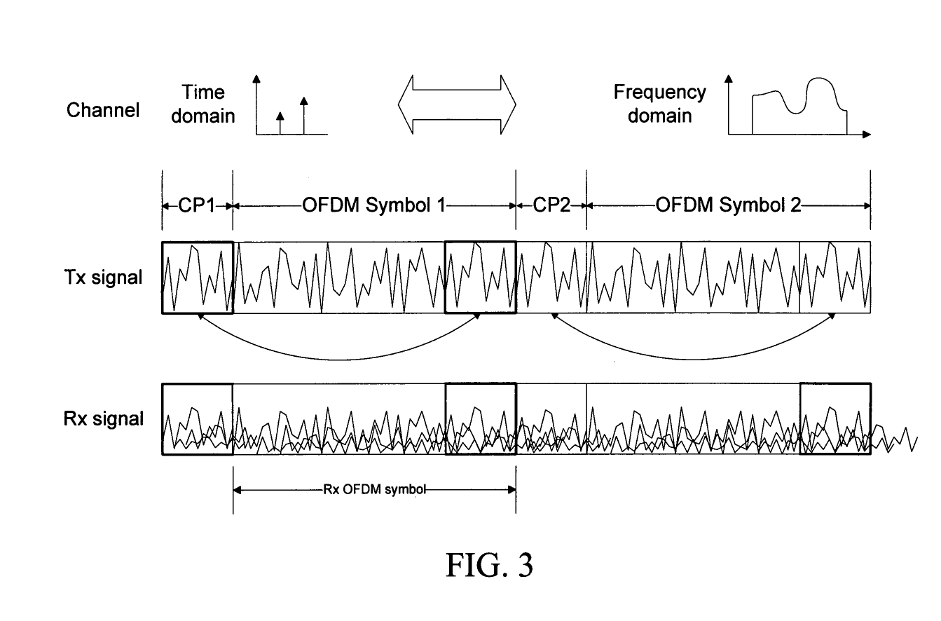

A time domain illustration of the transmitted and received OFDM symbols is shown in FIG. 3. Due to multipath fading, the CP portion of the received signal is often corrupted by the previous OFDM symbol. However, as long as the CP is sufficiently long, the received OFDM symbol without CP should only contain its own signal convoluted by the multipath fading channel. In general, a Fast Fourier Transform (FFT) is taken at the receiver side to allow further processing frequency domain. The advantage of OFDM over other transmission schemes is its robustness to multipath fading. The multipath fading in time domain translates into frequency selective fading in frequency domain. With the cyclic prefix or zero prefix added, the inter-symbol-interference between adjacent OFDM symbols are avoided or largely alleviated. Moreover, because each modulation symbol is carried over a narrow bandwith, it experiences a single path fading. Simple equalization scheme can be used to combat frequency selection fading.

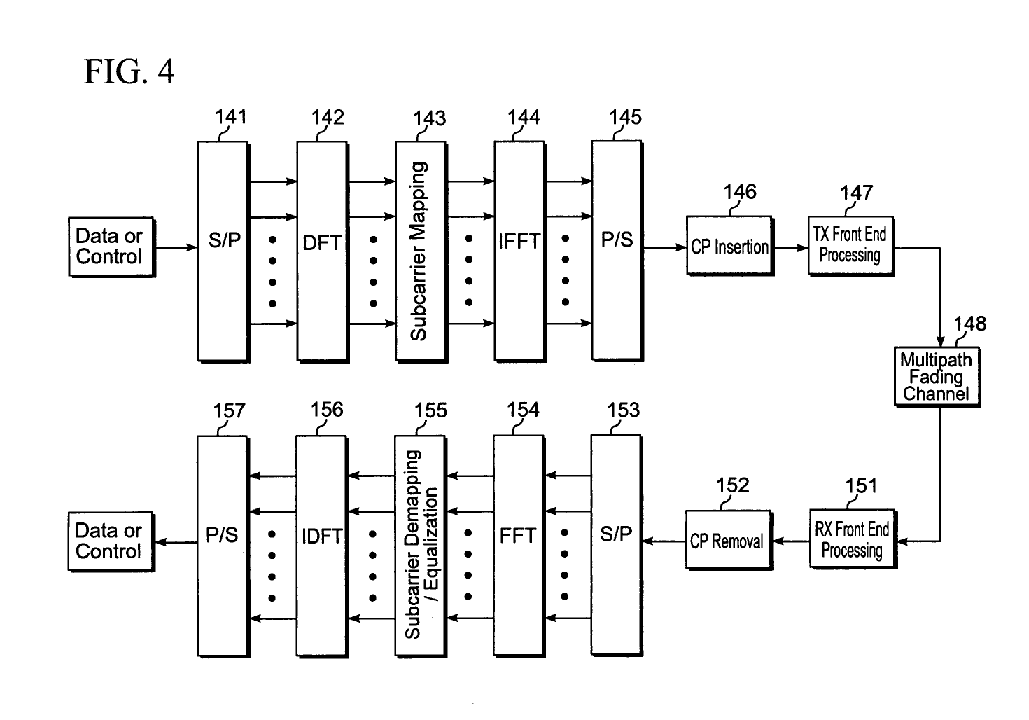

Single carrier frequency division multiple access (SC-FDMA), which utilizes single carrier modulation and frequency domain equalization is a technique that has similar performance and complexity as those of an OFDMA system. One advantage of SC-FDMA is that the SC-FDMA signal has lower peak-to-average power ratio (PAPR) because of its inherent single carrier structure. Low PAPR normally results in high efficiency of power amplifier, which is particularly important for mobile stations in uplink transmission. SC-FDMA is selected as the uplink multiple acess scheme in 3GPP long term evolution (LTE). An example of the transceiver chain for SC-FDMA is shown in FIG. 4. At the transmitter side, the data or control signal is serial to parallel (S/P) converted by a S/P convertor 181. Discrete Fourier transform (DFT) will be applied to time-domain data or control signal by a DFT transformer 182 before the time-domain data is mapped to a set of sub-carriers by a sub-carrier mapping unit 183. To ensure low PAPR, normally the DFT output in the frequency domain will be mapped to a set of contiguous sub-carriers. Then IFFT, normally with larger size than the DFT, will be applied by an IFFT transformer 184 to transform the signal back to time domain. After parallel to serial (P/S) convertion by a P/S/converter 185, cyclic prefix (CP) will be added by a CP insertion unit 186 to the data or the control signal before the data or the control signal is transmitted to a transmission front end processing unit 187. The processed signal with a cyclic prefix added is often referred to as a SC-FDMA block. After the signal passes through a communication channel 188, e.g., a multipath fading channel in a wireless communication system, the receiver will perform receiver front end processing by a receiver front end processing unit 191, remove the CP by a CP removal unit 192, apply FFT by a FFT transformer 194 and frequency domain equalization. Inverse Discrete Fourier transform (IDFT) 196 will be applied after the equalized signal is demapped 195 in frequency domain. The output of IDFT will be passed for further time-domain processing such as demodulation and decoding.

In packet-based wireless data communication systems, control signals transmitted through control channels, i.e., control channel transmission, generally accompany data signals transmitted through data channels, i.e., data transmission. Control channel information, including control channel format indicator (CCFI), acknowledgement signal (ACK), packet data control channel (PDCCH) signal, carries transmission format information for the data signal, such as user ID, resource assignment information, Payload size, modulation, Hybrid Automatic Repeat-reQuest (HARQ) information, MIMO related information.

Hybrid Automatic Repeat reQuestion (HARQ) is widely used in communication systems to combat decoding failure and improve reliability. Each data packet is coded using certain forward error correction (FEC) scheme. Each subpacket may only contains a portion of the coded bits. If the transmission for subpacket k fails, as indicated by a NAK in a feedback acknowledgement channel, a retransmission subpacket, subpacket k+1, is transmitted to help the receiver decode the packet. The retransmission subpackets may contain different coded bits than the previous subpackets. The receiver may softly combine or jointly decode all the received subpackets to improve the chance of decoding. Normally, a maximum number of transmissions is configured in consideration of both reliability, packet delay, and implementation complexity.

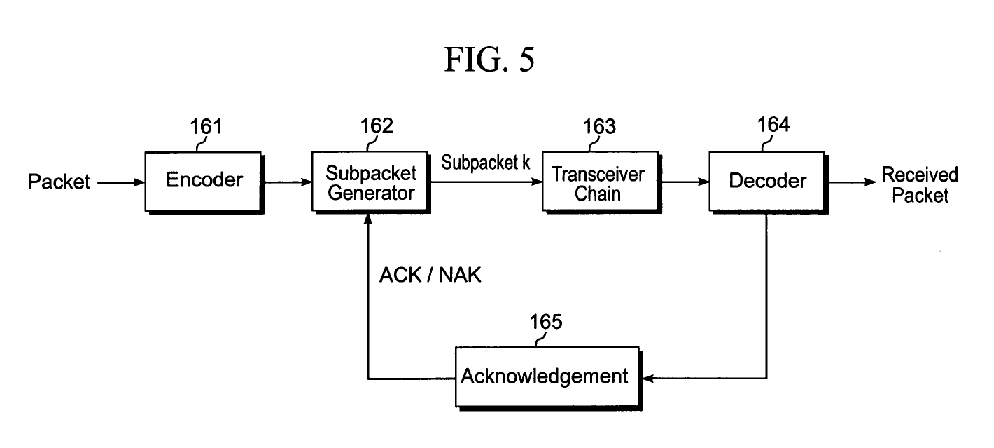

Due to its simplicity, N-channel synchronous HARQ are often used in wireless communication systems. For example, synchronous HARQ has been accepted as the HARQ scheme for LTE uplink in 3GPP. FIG. 5 shows an example of a 4-channel synchronous HARQ. Due to fixed timing relationship between subsequent transmissions, the transmission slots in the same HARQ channel exhibits an interlace structure. For example, interlace 0 consists of slot 0, 4, 8, . . . , 4k, . . . ; interlace 1 consists of slot 1, 5, 9, . . . , 4k+1, . . . ; interlace 2 consists of slot 2, 6, 10, . . . , 4k+2, . . . ; interlace 3 consists of slot 3, 7, 11, . . . 4k+3, . . . . Let's take interlace 0 as an example. A sub-packet is transmitted in slot 0. After correctly decoding the packet, the receiver sends back an ACK to the transmitter. The transmitter then can start a new packet at the next slot in this interlace, i.e., slot 4. However, the first subpacket transmitted in slot 4 is not correctly received. After the transmitter receives the NAK from the receiver, the transmitter transmits another sub-packet of the same packet at the next slot in this interlace, i.e., slot 8. Sometimes a receiver might have difficulty in detecting the packet boundary, i.e., whether a subpacket is the first sub-packet of a new packet or a retransmission sub-packet. To alleviate this problem, a new packet indicator may be transmitted in the control channel that carries transmission format information for the packet. Sometimes, a more elaborated version of HARQ channel information, such as sub-packet ID, or even HARQ channel ID, can be transmitted to help the receiver detect and decode the packet.

Multiple antenna communication systems, which is often referred to as multiple input multiple output (MIMO), are widely used in wireless communication to improve system performance. In a MIMO system, the transmitter has multiple antennas capable of transmitting independent signals and the receiver is equipped with multiple receive antennas. MIMO systems degenerates to single input multiple output (SIMO) if there is only one transmission antenna or if there is only one stream of data transmitted. MIMO systems degenerates to multiple input signle output (MISO) if there is only one receive antenna. MIMO systems degenerates to single input single output (SISO) if there is only one transmission antenna and one receive antenna. MIMO technology can significant increase throughput and range of the system without any increase in bandwidth or overall transmit power. In general, MIMO technology increases the spectral efficiency of a wireless communication system by exploiting the additional dimension of freedom in the space domain due to multiple antennas. There are many categories of MIMO technologies. For example, spatial multiplexing schemes increase the transmission rate by allowing multiple data streaming transmitted over multiple antennas. Transmit diversity methods such as space-time coding take advantage of spatial diversity due to multiple transmit antennas. Receiver diversity methods utilizes the spatial diversity due to multiple receive antennas. Beamforming technologies improve received signal gain and reducing interference to other users. Spatial division multiple access (SDMA) allows signal streams from or to multiple users to be transmitted over the same time-frequency resources. The receivers can separate the multiple data streams by the spatial signature of these data streams. Note these MIMO transmission techniques are not mutually exclusive. In fact, many MIMO schemes are often used in an advanced wireless systems.

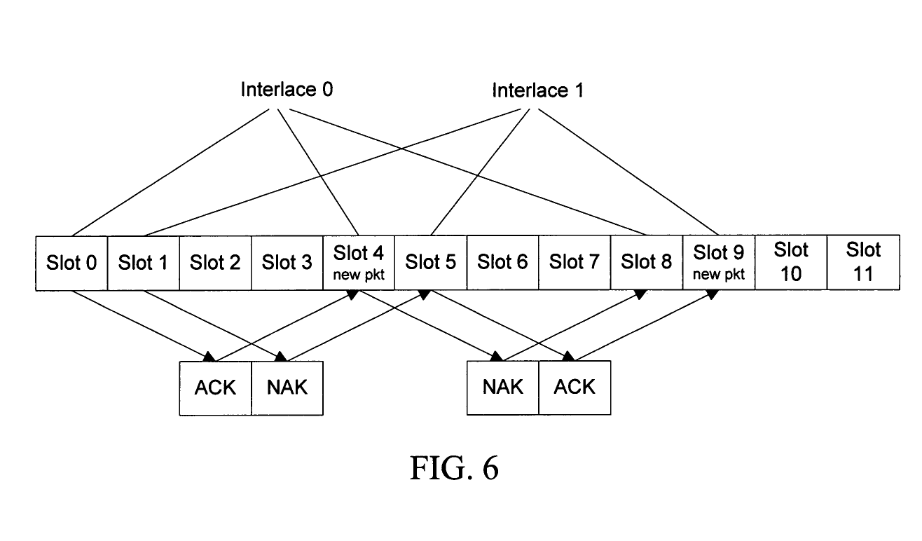

When the channel is favorable, e.g., the mobile speed is low, it is possible to use closed-loop MIMO scheme to improve system performance. In a closed-loop MIMO systems, the receivers feedback the channel condition and/or preferred Tx MIMO processing schemes. The transmitter utlizes this feedback information, together with other considerations such as scheduling priority, data and resource availability, to jointly optimize the transmission scheme. A popular closed loop MIMO scheme is called MIMO preceding. With preceding, the transmit data streams are pre-multiplied by a matrix before being passed on to the multiple transmit antennas. As shown in FIG. 6, assume there are Nt transmit antennas and Nr receive antennas. Denote the channel between the Nt transmit antennas and the Nr receive antennas as H. Therefore H is an Nt×Nr matrix. If the transmitter has knowledge about H, the transmitter can choose the most advantageous transmission scheme according to H. For example, if maximizing throught is the goal, the precoding matrix can be chosen to be the right singluar matrix of H, if the knowledge of H is available at the transmitter. By doing so, the effective channel for the multiple data streams at the receiver side can be diagonalized, eliminating the interference between the multiple data streams. However, the overhead required to feedback the exact value of H is often prohibitive. In order to reduce feedback overhead, a set of precoding matrices are defined to quantize the space of the possible values that H could substantiate. With the quantization, a receiver feeds back the preferred precoding scheme, normally in the form of the index of the preferred precoding matrix, the rank, and the indices of the preferred precoding vectors. The receiver may also feed back the associated CQI values for the preferred preceding scheme.

Another perspective of a MIMO system is whether the multiple data streams for transmission are encoded separately or encoded together. If all the layers for transmission are encoded together, we call it a single codeword (SCW) MIMO system. And we call it a multiple codeword (MCW) MIMO system otherwise. In the LTE downlink system, when single user MIMO (SU-MIMO) is used, up to 2 codewords can be transmitted to a single UE. In the case that 2 codewords are transmitted to a UE, the UE needs to acknowledge the two codewords separately. Another MIMO technique is called spatial division multiple access (SDMA), which is also referred to as multi-user MIMO (MU-MIMO) sometimes. In SDMA, multiple data streams are encoded separately and transmitted to different intended receivers on the same time-frequency resources. By using different spatial signature, e.g., antennas, virtual antennas, or precoding vectors, the receivers will be able to distinguish the multiple data streams. Moreover, by scheduling a proper group of receivers and choosing the proper spatial signature for each data stream based on channel state information, the signal of interest can be enhanced while the other signals can be enhanced for multiple receivers at the same time. Therefore the system capacity can be improved. Both single user MIMO (SU-MIMO) and multi-user MIMO (MU-MIMO) are adopted in the downlink of LTE. MU-MIMO is also adopted in the uplink of LTE while SU-MIMO for LTE uplink is still under discussion.

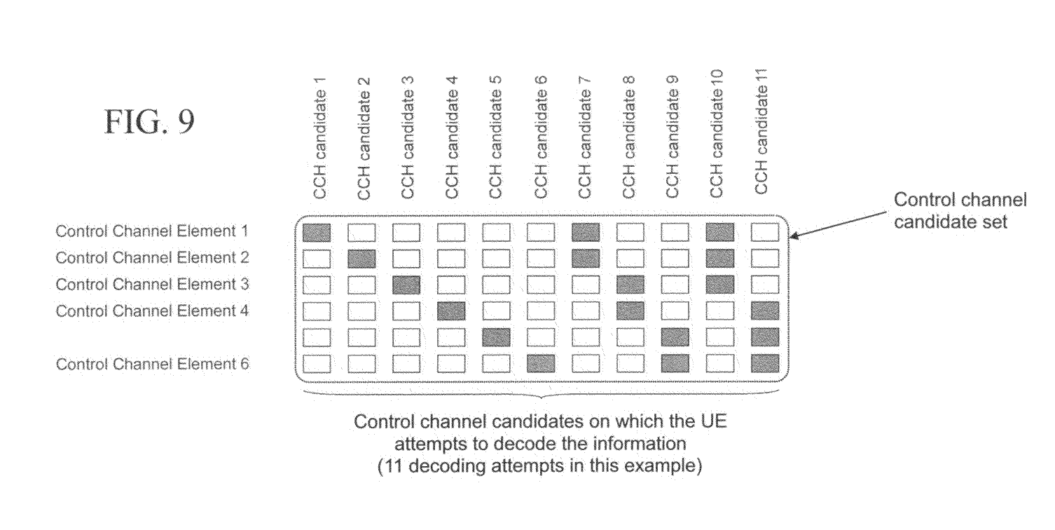

In LTE systems, some resources, namely control channel elements, are reserved for downlink control channel transmission. Control channel candidate set can be constructed based on the control channel elements reserved for downlink control channels. Each downlink control channel can be transmitted on one of the control channel candidate set. An example of control channel elements and control channel candidate set is shown in FIG. 9. In this example, 11 control channel candidate sets can be constructed on 6 control channel elements. In the rest of the document, we will refer to these control channel candidate sets as control channel resource sets, or simply, resource sets.

Aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive. The invention is illustrated by way of example, and not by way of limitation, in the figures of the accompanying drawings. In the following illustrations, we use downlink acknowledgement (ACK) channel in 3GPP LTE system as an example. However, the techniques illustrated here can certainly be applied to uplink acknowledgement channel in LTE systems, and in other channels and other systems whenever applicable.

During an uplink transmission, a unit of user equipment (UE) transmits a data packet to a base station (BS) after receiving an uplink scheduling grant (i.e., uplink grant) from the BS. In response to the received data packet from the UE, the BS transmits a downlink acknowledgement message (i.e., downlink ACK) to the UE. Similarly, during a downlink transmission, a BS transmits a data packet to a UE after transmitting a downlink scheduling grant (i.e., downlink grant) to the UE. In response to the received data packet from the BS, the UE transmits an uplink acknowledgement message (i.e., uplink ACK) to the UE.

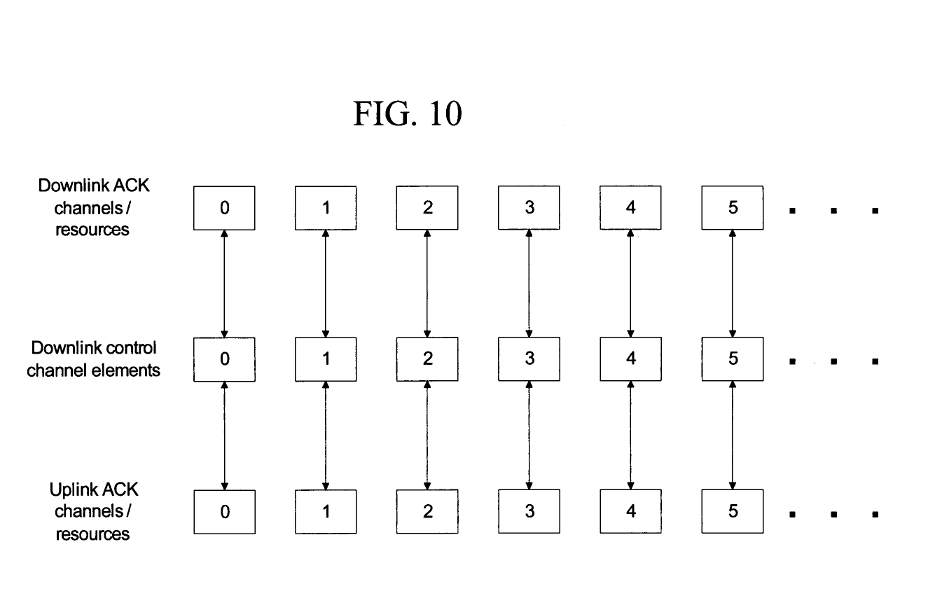

In a first embodiment according to the principles of the invention, we propose to establish a functional relationship, or mapping, between control channel elements and downlink Acknowledgement (ACK) channels or downlink ACK channel resources. This mapping is schematically illustrated in FIG. 10. As shown in FIG. 10, downlink ACK resource 0 is mapped to control channel element 0, downlink ACK resource 1 is mapped to control channel element 1, and so on. If control channel element 0 is used to deliver an uplink scheduling grant by a base station to a UE, the UE will expect to receive an acknowledgement message from the base station using downlink ACK resource 0 after the UE transmit a packet according to the uplink scheduling grant. In this way, an overhead signaling containing information regarding the downlink ACK channel resource allocation for this uplink transmission is omitted.

In a second embodiment according to the principles of the invention, we propose to establish a mapping between control channel elements and downlink ACK resources, while at the same time establish a mapping between the control channel elements and uplink ACK resources, as shown in FIG. 10. In FIG. 10, downlink ACK resource 0 is mapped to control channel element 0, and uplink ACK resource 0 is mapped to control channel element 0; downlink ACK resource 1 is mapped to control channel element 1, and uplink ACK resource 1 is mapped to control channel element 1; and so on. This technique achieves statistical multiplexing of downlink grants and uplink grants on the same set of control channel elements.

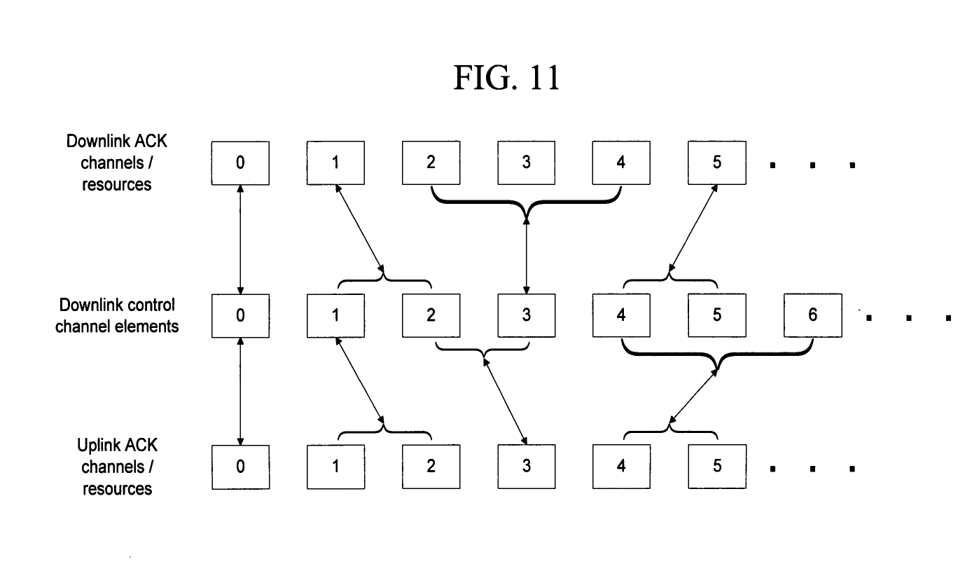

Certainly, the mapping between the control channel elements and the downlink ACK channel resources may vary; so does the mapping between the control channel elements and the uplink ACK channel resources. In addition, these two mappings need not to be directly related to each other. FIG. 11 illustrates a mapping scheme that is different from the one shown in FIG. 10, for both of the mapping from the control channel elements to the downlink ACK channel resources and the mapping from the control channel elements to the uplink ACK channel resources. As shown in FIG. 11, a mapping relationship can be one-to-one, one-to-many, and many-to-one. The mapping can certainly overlap. For example, while control channel element (CCE) 1 is mapped to downlink (DL) ACK 1 in FIG. 10, a group of CCE 1 and 2 is mapped to DL ACK 1 in FIG. 11. These two mapping relationships can be defined and used at the same time. In this case, if an uplink grant is transmitted using either CCE 1 or the group of CCE 1 and 2, the associated downlink ACK channel will be DL ACK 1. The mapping may also change over time and may be different for different UE. In addition, the mapping may depend on other information such as different HARQ transmissions, or MIMO configurations such as rank, whether the grant is a MIMO grant, a MCW MIMO grant, or a SCW MIMO grant, etc.

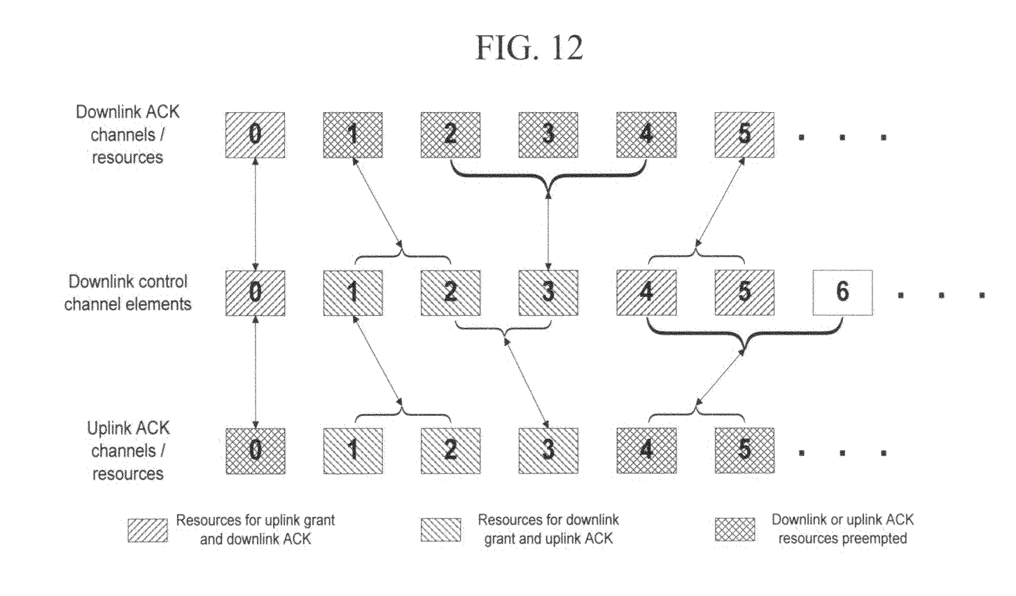

When some control channel elements are mapped to both of a downlink ACK channel and an uplink ACK channels, as shown in FIG. 12, the problem of ACK channel preemption arises. As shown in FIG. 12, control channel element 0 is used for an uplink grant. By the established mapping, downlink ACK channel 0 will be used to acknowledge the uplink transmission scheduled by this uplink grant. Note uplink ACK channel 0 is mapped to control channel element 0 as well. Because the control channel element 0 is already used, the usage of uplink ACK channel resource 0 is preempted. This may result in inefficiency in the ACK resource utilization. For example, as shown in FIG. 12, downlink ACK channel 1 is preempted because the corresponding control channel elements 1 and 2 are used for downlink grants by uplink ACK channels 1, 2 and 3. Similarly, downlink ACK channels 2, 3 and 4 are preempted because the corresponding control channel element 3 is used for downlink grants by uplink ACK channel 3. Also, uplink ACK channels 4, and 5 are preempted because the corresponding control channel elements 4, and 5 are used for uplink grants by downlink ACK channel 5.

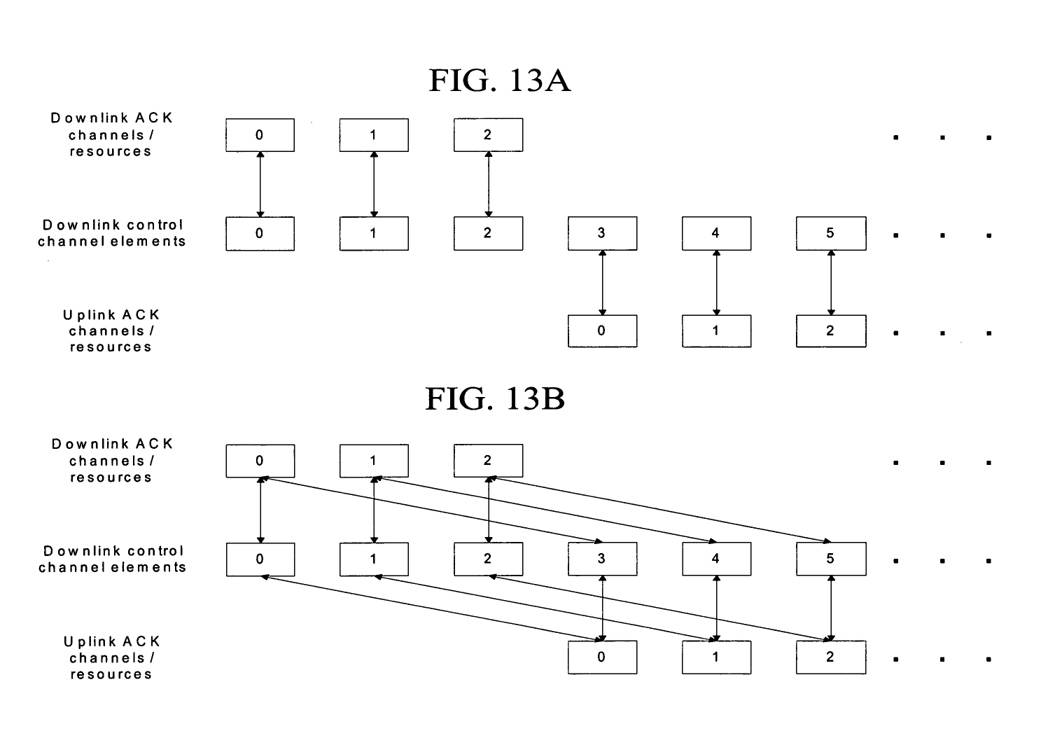

If we use separate control channel elements for downlink grant and uplink grant, we only need to allocate a control channel element to either an uplink ACK channel or a downlink ACK channel, as shown in FIG. 13A. The utilization of the control channel elements, however, would not be efficient. In order to improve the efficiency of control channel utilization, we propose to link at least one control channel element to both uplink and downlink ACK resources, as shown in FIG. 10. ACK channel preemption may, however, take place as shown in FIG. 12, leading to inefficient utilization of ACK resource. In order to effectively utilize both control channel elements and ACK channel resources, we propose to map multiple control channel elements to one downlink ACK channel resources in accordance with a third embodiment according to the principles of the present invention. Similarly, we propose to map multiple control channel elements to one uplink ACK channel resources. Both techniques are shown schematically in FIG. 13B. As shown in FIG. 13B, control channel elements 0 and 3 are mapped to downlink ACK channel resource 0; control channel elements 1 and 4 are mapped to downlink ACK channel resource 1; and control channel elements 2 and 5 are mapped to downlink ACK channel resource 2. Also, control channel elements 0 and 3 are mapped to uplink ACK channel resource 0; control channel elements 1 and 4 are mapped to uplink ACK channel resource 1; and control channel elements 2 and 5 are mapped to uplink ACK channel resource 2. Accordingly, if a downlink grant is sent on control channel element 0, uplink ACK resource 0 will be used to acknowledge the associated downlink transmission. The utilization of uplink ACK resource 0 does not, however, preempt the utilization of downlink ACK resource 0, because downlink ACK resource 0 is also mapped to control channel element 3. In fact, the proposed mapping technique enables statistical multiplexing of downlink grant and uplink grant while significantly mitigating the problem of ACK channel preemption.

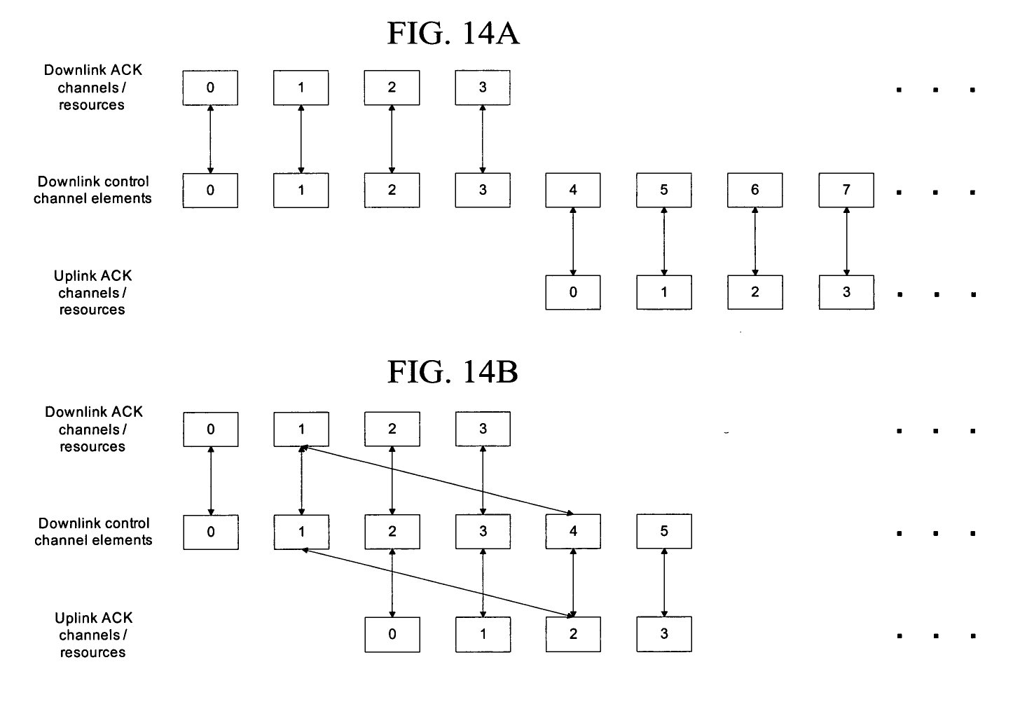

Certainly, the aforementioned embodiments of mapping between control channel elements and ACK channel resources can be mixed, i.e., can be used simultaneously. One example is shown in FIGS. 14A and 14B. FIG. 14A illustrates a scheme of separately mapping control channel elements to either an uplink ACK channel or a downlink ACK channel as an comparative example. FIG. 14B illustrates a scheme of mixing multiple mapping schemes in accordance with a fourth embodiment according to the principles of the present invention. One of the benefits, among many other benefits, of the mixed scheme is to achieve flexible tradeoff between the utilization efficiency of control channel elements and ACK channel resources. As shown in FIG. 14B, by establishing the mapping from CCE 0 to DL ACK 0, there will be no preemption problem on DL ACK 0, because CCE 0 will always be available for an uplink grant. Similarly, by establishing the mapping from CCE5 to UL ACK 3, there will be no preemption problem on UL ACK 3 because CCE 5 will always be available for a downlink grant. By establishing the mapping from CCE 1, 2, 3, and 4 to both uplink ACK resources and downlink ACK channel resources, we enable statistical multiplexing between downlink grants and uplink grants to increase utilization on control channel elements, thus reducing control channel overhead. As shown in FIG. 14B, only six control channel elements are needed to support four downlink ACK channels and four uplink ACK channels, whereas in FIG. 14A, eight control channel elements are needed to support four downlink ACK channels and four uplink ACK channels. In addition, by establishing the mapping from both CCE 1 and 4 to DL ACK 1, and the mapping from both CCE 1 and 4 to UL ACK 2, we mitigate the ACK channel preemption problem for DL ACK 1 and UL ACK 2.

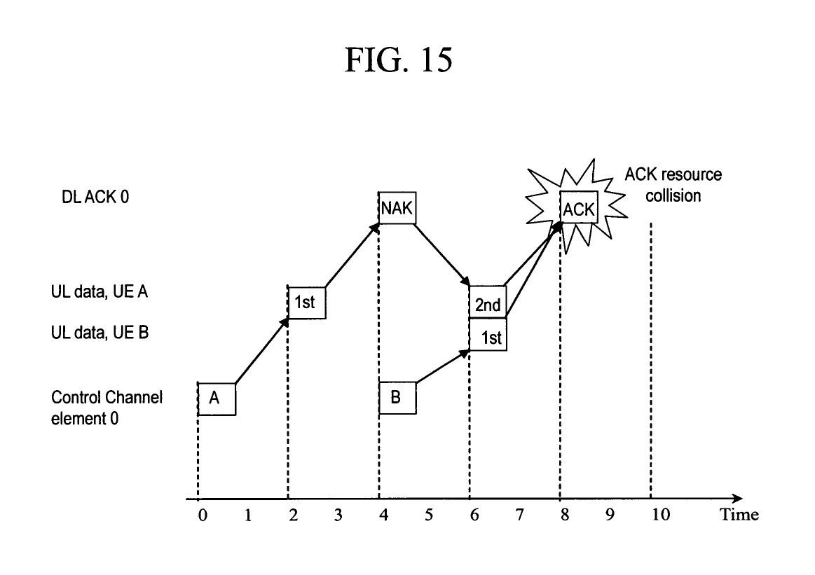

In certain HARQ operations, such as synchronous HARQ, no grant or assignment is required for retransmission. For illustration purpose, assume an uplink transmission uses synchronous HARQ. As shown in FIG. 15, one uplink grant is sent to UE A by a base station at time 0 using control channel element 0. UE A transmits a data packet to the base station at time 2. The base station sends a NAK at time 4 to request retransmission from UE A for that packet. Assume control channel element 0 is associated with DL ACK 0. Therefore both the base station and the UE know DL ACK0 will be used at time 4 for acknowledgement for the packet UE A transmitted at time 2. Similarly, after the second (2^{nd}) transmission at time 6, both the base station and the UE know that DL ACK 0 will still be used at time 8 for acknowledging the 2^{nd} transmission. Simultaneously, the base station sends an uplink grant to UE B at time 4 using control channel element 0. UE B transmits a data packet to the base station at time 6. Assume the mapping scheme between control channel elements and the DL ACK channel resources is the same for both UE A and UE B. In other words, control channel element 0 is associated with DL ACK 0 for both UE A and UE B. Then, the base station sends a NAK to UE B at time 8 using DL ACK 0. The simultaneous utilization of DL ACK 0 for both UE A and UE B at time 8 would result in ACK channel resource collision at time 8. Therefore, the base station cannot use control channel element 0 at time 4 to send another uplink grant to UEs other than UE A. Effectively, the control channel element that is associated with the ACK resource for this HARQ session is put on hold, resulting in inefficiency in control channel element utilization. In LTE uplink, there may not be uplink grant for uplink retransmission. The base station can only decide which downlink ACK channel to use to acknowledge or negatively acknowledge (ACK/NAK) an uplink retransmission based on which control channel element was used for the uplink scheduling grant for the uplink initial transmission. Therefore, once a data packet is in transmission (i.e., being either transmitted or retransmitted), the control channel element used to transmit the uplink scheduling grant cannot be used to schedule another user. In this case, the control channel element is “blocked”.

In one embodiment of the invention, we propose to establish, for at least one UE, a mapping scheme between control channel elements and ACK channel resources that is different from the mapping schemes used by other UEs in accordance with a fifth embodiment according to the principles of the present invention. For example, assume there are N ACK resources and M UEs. Assume the indices of the UEs are 0, 1, . . . , M-1. The mapping from ACK resource i to control channel element CCE(i, j) for UE j may be defined such that the index of the ACK resource that is allocated to control channel element CCE(i, j) for UE j is established by:

CCE(i, j)=(i+j) mod N, for j=0, 1, . . . , M-1 (1)

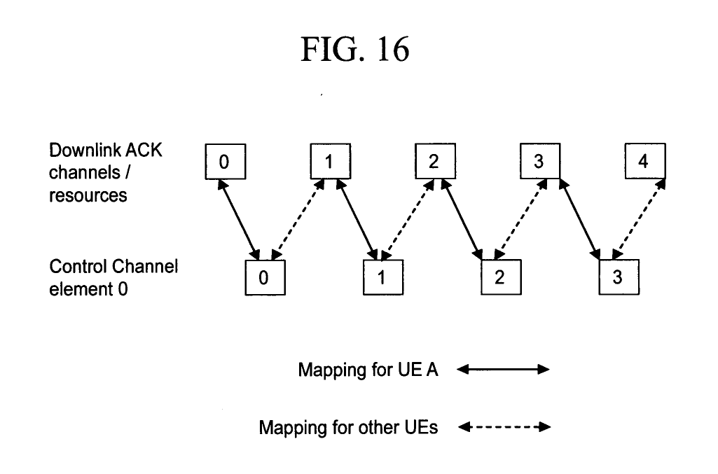

To give a more specific example, assume there are four control channel elements and five ACK resources as shown in FIG. 16. For UE 0, the mapping is defined as CCE 0 mapped to ACK 0, CCE 1 mapped to ACK1, CCE 2 mapped to ACK 2, and CCE 3 mapped to ACK 3. For the rest of the UEs, the mapping scheme is defined as CCE 0 mapped to ACK 1, CCE 1 mapped to ACK 2, CCE 2 mapped to ACK 3, and CCE 3 mapped to ACK 4. By doing so, if CCE 0 is used for sending an uplink grant to UE 0 to start an HARQ session, ACK 0 will be used for acknowledgments of that HARQ session. Each of the four CCEs can still be used, however, to schedule other UEs without being held by the ongoing HARQ session of UE 0. Certainly, various mappings can be defined to achieve different mapping for different UE. For example, the index of the ACK resource that is allocated to control channel element CCE(i, j) for UE j may be established by:

CCE(i, j)=(i+f(j)) mod N, for j=0, 1, . . . , M-1, (2)

where f(j) can be any function of j, e.g., a Hash function.

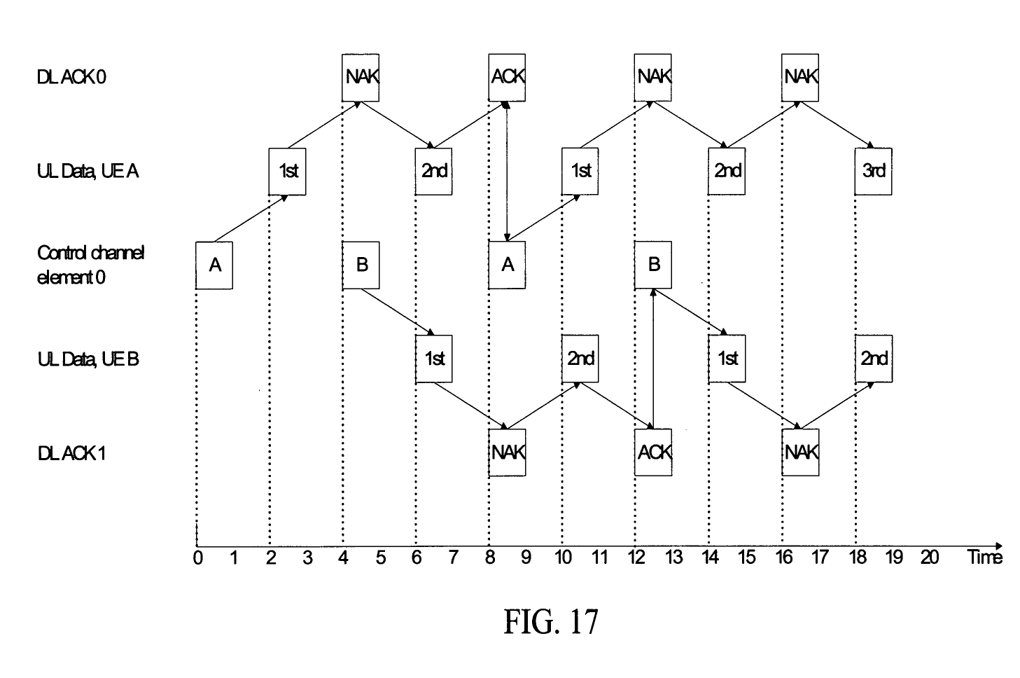

Alternatively, we can establish in at least one time unit a mapping scheme between control channel elements and ACK channel resources that is different from the mapping schemes used in other time units in accordance with a sixth embodiment according to the principles of the present invention. For example, as shown in FIG. 17, if we map CCE 0 to DL ACK 0 at time 0 and 8, and map CCE 0 to DL ACK 1 at time 4 and 12, we can also avoid holding up CCE 0 by DL ACK 0 without defining UE specific mapping. To be more specific, when a first uplink grant is sent to UE A at time 0 using CCE 0, DL ACK 0 will be used to acknowledge the HARQ session initiated by the first uplink grant at time 8. When a second uplink grant is sent to UE B at time 4 using CCE 0, DL ACK 1 will be used to acknowledge the HARQ session initiated by the second uplink grant at time 8. By doing so, although both HARQ sessions are initiated by uplink grants on CCE 0, they use different ACK resources. So, at time 8, there are two acknowledgements, one transmitted on DL ACK 0 by UE A and the other transmitted on DL ACK 1 by UE B. No ACK resource collision is caused by using CCE 0 to send uplink grant to UE B while the HARQ session of UE A is still ongoing. By doing so, we avoid CCE 0 being held up by the said first HARQ session.

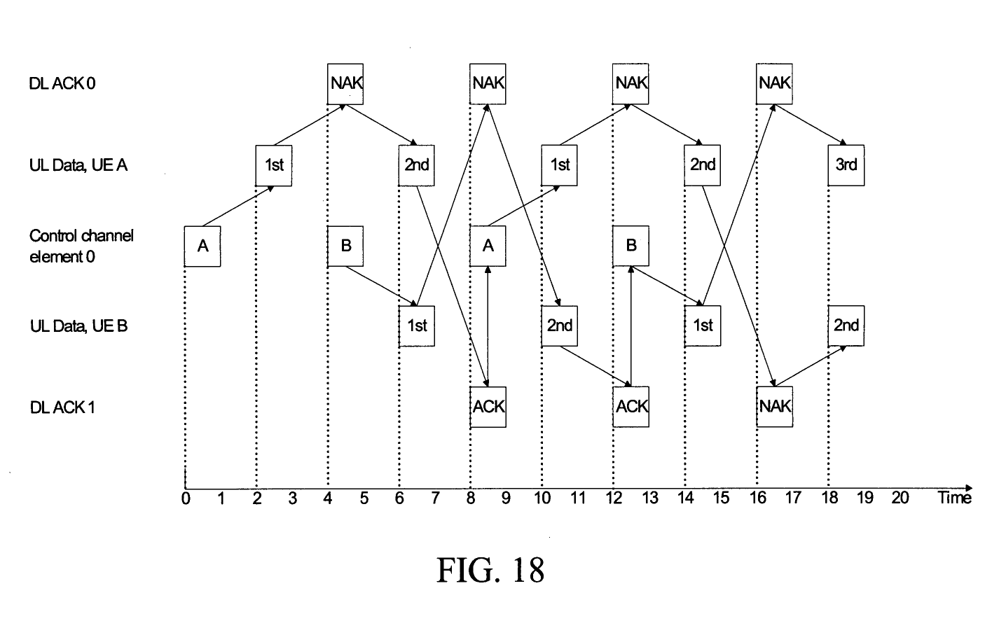

Certainly, various time-specific mappings can be defined to avoid ACK resource collision or blocking of the control channel elements. In a seventh embodiment according to the principles of the present invention, the mapping may be defined for each HARQ transmission. As shown in FIG. 18, for an HARQ session initiated by an uplink grant sent on CCE 0, the first transmission should be acknowledged using DL ACK 0, the second transmission should be acknowledged using DL ACK 1. In this way, ACK channel collision or blocking of the control channel elements can also be avoided. To be more specific, when a first uplink grant is sent to UE A at time 0 using CCE 0 to initiate a first HARQ session, DL ACK 0 will be used at time 4 to acknowledge the first transmission, and DL ACK 1 will be used at time 8 to acknowledge the second transmission, if occurred, of the said first HARQ session. When a second uplink grant to UE B is sent on CCE 0 at time 4, DL ACK 0 will be used at time 8 to acknowledge the first transmission of a second HARQ session initiated by the said second uplink grant. By doing so, although both HARQ sessions are initiated by uplink grants on CCE 0, they use different ACK resources at the same time unit. So, at time 8, there are two acknowledgements, one transmitted on DL ACK 1 by UE A and the other transmitted on DL ACK 0 by UE B. No ACK resource collision is caused by using CCE 0 to send uplink grant to UE B while the HARQ session of UE, A is still ongoing. Assume maximum of four transmissions for an HARQ session, we can extend the technique such that for an HARQ session initiated by an uplink grant sent on CCE 0, the first transmission should be acknowledged using DL ACK 0, the second transmission should be acknowledged using DL ACK 1, the third transmission should be acknowledged using DL ACK 2, the fourth transmission should be acknowledged using DL ACK 4. We can also extend the rule such that for an HARQ session initiated by an uplink grant sent on CCE 0, the first transmission should be acknowledged using DL ACK 0, the other transmissions should be acknowledged using DL ACK 1.

Note that with the aforementioned embodiments, the blocking of control channel elements may still take place under certain conditions. In general, when the usage of a control channel element to transmit a grant message would result in ACK channel collision, the usage of the control channel element at that time should be prohibited. In other words, the control channel element should be blocked. In that case, the blocked control channel elements can be used to deliver other messages. For example, if one control channel element is blocked for sending uplink grants, it may be used to send downlink grant. This is particularly useful when one link (e.g., downlink) uses asynchronous HARQ while the other link (e.g., uplink) uses synchronous HARQ. In general, each transmission of an asynchronous HARQ process requires a grant. So there will always be an ACK resource for a transmission as long as there is a control channel element available for a grant of that transmission. On the other hand, a synchronous HARQ session requires only one grant for the whole HARQ session but needs ACK resources for all transmissions. In the case that mapping is established between control channel elements with both downlink ACK resources and uplink ACK resources, if downlink data transmission uses asynchronous HARQ and uplink data transmission uses synchronous HARQ, rules can be made such that priority in choosing control channel elements can be given to uplink grants to mitigate the problem of blocking control channel elements. Because downlink asynchronous HARQ sessions do not block control channel elements, the leftover control channel elements can be used to transmit downlink grants.

In a ninth embodiment according to the principles of the invention, mapping can be established between the control channel elements and the ACK resource for persistent transmissions assigned by the persistent assignment transmitted on those control channel elements. Similarly to synchronous HARQ, persistent assignment will also have similar problem of blocking control channel elements. So the aforementioned embodiments apply. That is, the problem of blocking is resulted from the fact that there is no scheduling grant for transmissions or retransmissions. So the ACK channel assigned to the receiver to respond to these transmissions is determined based on the control channel element used to transmit the scheduling grant of the first transmission. Persistent assignment fits this profile. In the case of persistent assignment, a base station transmits a persistent assignment to a unit of user equipment which grants to the unit of user equipment the usage of a resource for a period of time. In contrast, a non-persistent assignment (scheduling grant) is transmitted to a unit of user equipment which grants to the unit of user equipment the usage of a resource for one or few transmissions. A resource typically refers to the frequency bandwidth and to the time slots for data channel transmission (i.e., uplink data channel in this case). If the ACK channel is determined by the control channel element used to transmit the initial scheduling grant of a persistent assignment, the ACK channel will always be used to respond to the persistent transmissions that are the transmissions on the persistently assigned resources. In that case, the control channel element used to transmit the initial scheduling grant is blocked unless a mapping scheme is established between the ACK resource and control channel elements in accordance with the principles of the present invention. In other words, the control channel element used to transmit the initial scheduling grant of a persistent assignment cannot be used to transmit another scheduling grant or persistent assignment. Otherwise, ACK collision may take place.

What is claimed is:

1. A method for communication, the method comprising the steps of:
establishing a mapping scheme between a plurality of control channel elements and a plurality of acknowledgement channel resources;
in response to a scheduling grant transmitted using a control channel element selected from the plurality of control channel element, transmitting a data packet via a second node to a first node; and
transmitting via the first node, one of an acknowledgement message and a negative acknowledgement message using an acknowledgement channel resource selected from the plurality of acknowledgement channel resources in accordance with the mapping scheme.

2. The method of claim 1, comprised of the mapping scheme comprising at least one mapping relationship selected from a group of mapping relationships comprising:
one acknowledgement channel resource corresponding to one control channel element;
one acknowledgement channel resource corresponding to more than one control channel element;
more than one acknowledgement channel resource corresponding to one control channel element; and
more than one acknowledgement channel resource corresponding to more than one control channel element.

3. The method of claim 1, comprised of the first node being a base station, the second node being a unit of user equipment, and the acknowledgement channel resources being downlink acknowledgement channel resources.

4. The method of claim 3, comprised of the mapping scheme changing for different unit of user equipment.

5. The method of claim 1, comprised of the mapping scheme changing over time.

6. The method of claim 1, comprised of the mapping scheme changing in dependence upon one of information regarding Hybrid automatic repeat-request transmission, and information regarding Multiple-Input Multiple-Output configuration comprised of ranking information and whether a grant is a Multiple-Input Multiple-Output grant, or a multiple codeword grant, or a single codeword grant.

7. A methof for communication, the method comprising the steps of:
establishing one or a plurailty of first mapping schemes between a plurality of control channel elements and a plurality of downlink acknowledgement channel resources for a plurlaity of units of user equipment;
establishing one or a plurailty of second mapping schemes between the plurality of control channel elements and a plurality of uplink acknowledgement channel resources for the plurlaity of units of user equipment;
when any one of the pluraltiy of units of user equipment receives an uplink scheduling grant from a base station via a control channel element and the unit of user equipment transmits a data packet to the base station, transmitting via the base station, one of a downlink acknowledgement message and a downlink negative acknowledgement message by using at least one downlink acknowledgement channel resource that is associated with the control channel element in accordance with the first mapping scheme that corresponds to the unit of user equipment; and
when a base station transmits a downlink scheduling grant via a control channel element and a data packet via a data channel to any one of the plurality of units of user equipment, transmitting via the unit of user equipment, one of an uplink acknowledgement message and an uplink negative acknowledgement message by using at least one uplink acknowledgement channel resource that is associated with the control channel element in accordance with the second mapping scheme that corresponds to the unit of user equipment.

8. The method of claim 7, comprised of,
in accordance with the first mapping schemes, more than one control channel element corresponding to one downlink acknowledgement channel resource; and
in accordance with the second mapping schemes, more than one control channel element corresponding to one uplink acknowledgement channel resource.

9. The method of claim 7, comprised of each one of the first mapping schemes and the second mapping schemes comprising at least one mapping relationship selected from a group of mapping relationships comprising:
one acknowledgement channel resource corresponding to one control channel element;
one acknowledgement channel resource corresponding to more than one control channel element;
more than one acknowledgement channel resource corresponding to one control channel element; and
more than one acknowledgement channel resource corresponding to more than one control channel element.

10. The method of claim 9, comprised of, for at least one of the units of user equipment, the corresponding first mapping scheme being the same as the corresponding second mapping scheme.

11. The method of claim 9, comprised of, for at least one of the units of user equipment, the corresponding first mapping schemes being different from the corresponding second mapping scheme.

12. The method of claim 7, comprised of at least one of the first mapping schemes and the second mapping schemes changing over time.

13. The method of claim 7, comprised of at least one of the first mapping schemes and the second mapping schemes changing in dependence upon one of information regarding Hybrid automatic repeat-request transmission, and information regarding Multiple-Input Multiple-Output configuration comprised of ranking information and whether a grant is a Multiple-Input Multiple-Output grant, or a multiple codeword grant, or a single codeword grant.

14. The method of claim 7, comprised of, at least one of the first mapping schemes being different from the other first mapping schemes, and at least one of the second mapping schemes being different from the other second mapping schemes.

15. A methof for communication, the method comprising the steps of:
establishing one or a plurality of mapping schemes between a plurality of control channel elements and a plurality of downlink acknowledgement channel resources for corresponding ones of a plurality of units of user equipment; and
when any one of the plurality of units of user equipment receives an uplink scheduling grant from a base station via a control channel element selected from the plurality of control channel elements and the unit of user equipment transmits a data packet to the base station, transmitting via the base station, one of a downlink acknowledgement message and a downlink negative acknowledgement message by using at least one downlink acknowledgement channel resource that is associated with the control channel element in accordance with a mapping scheme corresponding to the unit of user equipment.

16. The method of claim 15, with at least one mapping scheme being different from the other mapping schemes.

17. The method of claim 16, comprised of, in accordance with at least one mapping scheme, when there are N downlink acknowledgement channel resources and M units of user equipment, the index CCE(i,j) for the control channel element that corresponds to an i-th downlink acknowledgement channel resource for a j-th unit of user equipment being established as:
CCE(i,j)=(i+j) mod N, for j=0, 1, . . . M-1.

18. The method of claim 16, comprised of, in accordance with at least one mapping scheme, when there are N downlink acknowledgement channel resources and M units of user equipment, the index CCE(i,j) for the control channel element that corresponds to an i-th downlink acknowledgement channel resource for a j-th unit of user equipment being established as:
CCE(i,j)=(i+f(j)) mod N, for j=0, 1, . . . M-1.
where f(j) is a certain function of j.

19. The method of claim 18, comprised of f(j) being a Hash function.

20. The method of claim 15, comprised of, when anyone of the units of user equipment receives a downlink negative acknowledgement message from the base station, retransmitting a data packet via the unit of user equipment.

21. The methd of claim 15, comprised of at least one mapping scheme changing in dependence upon an index of retransmission.

22. The method of claim 15, comprised of at least one mapping scheme changing over time.

23. A base station in a wireless communication system, with the base station:
establishing and broadcasting parameters that configure one or a plurality of first mapping schemes between a plurality of control channel elements and a plurality of downlink acknowledgement channel resources for a plurlaity of units of user equipment;
establishing and broadcasting parameters that configure one or a plurality of second mapping schemes between the plurality of control channel elements and a plurality of uplink acknowledgement channel resources for the plurlaity of units of user equipment; and
when any one of the pluraltiy of units of user equipment receives an uplink scheduling grant from the base station via a control channel element and the unit of user equipment transmits a data packet to the base station, transmitting one of a downlink acknowledgement message and a downlink negative acknowledgement message by using at least one downlink acknowledgement channel resource that is associated with the control channel element in accordance with the first mapping scheme that corresponds to the unit of user equipment.

24. The base station of claim 23, comprised of each one of the first mapping schemes and the second mapping schemes comprising at least one mapping relationship selected from a group of mapping relationships comprising:
one acknowledgement channel resource corresponding to one control channel element;
one acknowledgement channel resource corresponding to more than one control channel element;
more than one acknowledgement channel resource corresponding to one control channel element; and
more than one acknowledgement channel resource corresponding to more than one control channel element.

25. The base station of claim 23, comprised of, at least one of the first mapping schemes being different from the other first mapping schemes, and at least one of the second mapping schemes being different from the other second mapping schemes.

26. The base station of claim 23, comprised of at least one of the first mapping schemes and the second mapping schemes changing over time.

27. A unit of user equipment, comprising:
a memory unit for storing a first mapping scheme between a plurality of control channel elements and a plurality of downlink acknowledgement channel resources, and a second mapping scheme between the plurality of control channel elements and a plurality of uplink acknowledgement channel resources,
with, when the unit of user equipment receives an uplink scheduling grant from a base station via a control channel element and the unit of user equipment transmits a data packet to the base station, receiving from the base station one of a downlink acknowledgement message and a downlink negative acknowledgement message by using at least one downlink acknowledgement channel resource that is associated with the control channel element in accordance with the first mapping scheme, and
with, when the unit of user equipment receives a downlink scheduling grant via a control channel element and receives a data packet via a data channel from a base station, transmitting one of an uplink acknowledgement message and an uplink negative acknowledgement message by using at least one uplink acknowledgement channel resource that is associated with the control channel element in accordance with the second mapping scheme.
